(19) United States
(12) Patent Application Publication
(10) Pub. No.: US 2025/0128176 A1
(43) Pub. Date: Apr. 24, 2025

(54) IN-GAME TEAM-FORMING METHOD, DEVICE, EQUIPMENT, AND STORAGE MEDIUM

(71) Applicant: NetEase (Hangzhou) Network Co., Ltd., Hangzhou (CN)

(72) Inventor: Zhenyu LIU, Hangzhou (CN)

(21) Appl. No.: 18/546,265

(22) PCT Filed: Apr. 21, 2022
(86) PCT No.: PCT/CN2022/088253

§ 371 Date: Aug. 11, 2023

(30) Foreign Application Priority Data
Oct. 9, 2021 (CN) 202111177805.X

(51) Int. Cl. A63F 13/795; A63F 13/42; G06F 3/0486

(52) U.S. Cl. CPC A63F 13/795; A63F 13/42; G06F 3/0486; A63F 2300/308; A63F 2300/5566

(57) ABSTRACT

The present disclosure provides in-game team-forming method, device, equipment, and storage medium, relating to the technical field of online games. A graphical user interface of the game is provided by a terminal device, and a team-forming control is provided on the graphical user interface. The method includes: determining, in response to a touch operation on the team-forming control, a target object according to the touch operation; determining a target team-forming mode corresponding to the target object based on a mapping relationship between the object and a team-forming mode, wherein the target team-forming mode at least includes a team-forming task; and triggering, according to the target team-forming mode, a team-forming instruction corresponding to the target team-forming mode. The present disclosure can reduce the team-forming complexity, and improve the team-forming efficiency.

### CROSS-REFERENCE TO RELATED APPLICATION

The present disclosure claims the priority to the Chinese patent application with the filing No. 202111177805.X, filed on Oct. 9, 2021 with the China National Intellectual Property Administration, and entitled “In-game Team-Forming Method, Device, Equipment, and Storage Medium”, the contents of which are incorporated by reference herein in entirety.

### TECHNICAL FIELD

The present disclosure relates to the technical field of online games, and in particular, to in-game team-forming method, device, equipment, and storage medium.

### BACKGROUND ART

In a multiplayer online game, a plurality of players usually need to form a team to complete a certain task. Generally, one player initiates team forming, and then other multiple players join the team to achieve the team forming.

In the prior art, there is usually a sub-interface dedicated to form a team on a game interface, and a player can select name of a corresponding playing method according to different playing methods actually required, and further establish a team according to this playing method.

However, since there are usually many types of playing methods in which a team can be formed in a game, a player cannot remember the name of each playing method, which results in that when forming a team in some playing methods, a large number of processes are required to establish a team for a corresponding playing method, that is to say, the process of forming a team is relatively complex and the team-forming efficiency is relatively low.

### SUMMARY

The present disclosure aims at providing an in-game team-forming method, device, equipment, and storage medium, which can reduce the team-forming complexity and improve the team-forming efficiency.

Embodiments of the present disclosure are realized as follows.

In one aspect of the embodiments, the present disclosure provides in-game team-forming method, device, equipment, and storage medium, wherein a graphical user interface of the game is provided by a terminal device, and a team-forming control is provided on the graphical user interface. The method includes: determining, in response to a touch operation on the team-forming control, a target object according to the touch operation;
determining a target team-forming mode corresponding to the target object based on a mapping relationship between the object and a team-forming mode, wherein the target team-forming mode at least includes a team-forming task; and
triggering, according to the target team-forming mode, a team-forming instruction corresponding to the target team-forming mode.

Optionally, a first touch point of the touch operation is located on the team-forming control, and a second touch point of the touch operation is located on the target object.

Optionally, the touch operation is a dragging operation, and the step of determining a target object according to the touch operation includes:
determining an object located at an end point position of the dragging operation as the target object.

Optionally, the touch operation is a dragging operation, and the step of determining a target object according to the touch operation includes:
making the team-forming control move to the end point position of the dragging operation based on a dragging track of the dragging operation, in response to the dragging operation on the team-forming control.

Optionally, the touch operation includes a first touch operation and a second touch operation, and the step of determining, in response to a touch operation on the team-forming control, a target object according to the touch operation includes:
determining an object at a target position as the target object in response to the first touch operation on the team-forming control and the second touch operation on the target position.

Optionally, the target object includes: a control, a scene object, and a character object.

Optionally, the step of triggering, according to the target team-forming mode, a team-forming instruction corresponding to the target team-forming mode includes:
displaying a team-forming confirmation sub-interface on the graphical user interface, wherein the team-forming confirmation sub-interface at least includes: a target team-forming mode; and
triggering a team-forming instruction corresponding to the target team-forming mode in response to a confirmation operation on the team-forming confirmation sub-interface.

Optionally, the team-forming confirmation sub-interface further includes a team-forming option control, and this method further includes:
sending preset team-forming information corresponding to the team-forming option control by means of instant communication, after establishing a team corresponding to the target team-forming mode, in response to a selection operation on the team-forming option control.

Optionally, the step of determining a target team-forming mode corresponding to the target object based on a mapping relationship between the object and a team-forming mode includes:
acquiring a pre-configured mapping relationship data table, wherein the mapping relationship data table reflects a mapping relationship between identification information and a team-forming mode of an object; and
determining the target team-forming mode according to the identification information about the target object, based on the mapping relationship between the identification information and the team-forming mode of the object in the mapping relationship data table.

Optionally, the identification information includes: text identification, and the mapping relationship data table includes a first mapping relationship; and the step of determining the target team-forming mode according to the identification information about the target object, based on the mapping relationship between the identification information and the team-forming mode of the object in the mapping relationship data table includes:
acquiring the first mapping relationship, wherein the first mapping relationship is used to indicate the mapping relationship between the text identification and the team-forming mode of the object; and
taking a team-forming mode corresponding to the text identification of the target object as the target team-forming mode, based on the first mapping relationship.

Optionally, before acquiring the first mapping relationship, the method further includes:
establishing the first mapping relationship between the text identification and the team-forming mode of the object in response to an association configuration operation.

Optionally, the identification information includes: image identification, and the mapping relationship data table includes a second mapping relationship; and the step of determining the target team-forming mode according to the identification information about the target object, based on the mapping relationship between the identification information and the team-forming mode of the object in the mapping relationship data table includes:
acquiring the second mapping relationship, wherein the second mapping relationship is used to indicate the mapping relationship between the image identification and the team-forming mode of the object; and
taking a team-forming mode corresponding to the image identification of the target object as the target team-forming mode, based on the second mapping relationship.

Optionally, before acquiring the second mapping relationship, the method further includes:
establishing the second mapping relationship between the image identification and the team-forming mode of the object in response to an association configuration operation.

In another aspect of the embodiments, the present disclosure provides an in-game team-forming device, wherein a graphical user interface of the game is provided by a terminal device, and a team-forming control is provided on the graphical user interface. The device includes: a responding module, a determining module, and a triggering module, wherein
the responding module is configured to determine, in response to a touch operation on the team-forming control, a target object according to the touch operation;
the determining module is configured to determine a target team-forming mode corresponding to the target object based on a mapping relationship between the target object and a team-forming mode, wherein the target team-forming mode at least includes the team-forming task; and
the triggering module is configured to trigger, according to the target team-forming mode, a team-forming instruction corresponding to the target team-forming mode.

Optionally, in the device, a first touch point of the above touch operation is located on the team-forming control, and a second touch point of the touch operation is located on the target object.

Optionally, the touch operation is a dragging operation, and the responding module is specifically configured to determine an object at an end point position of the dragging operation as a target object.

Optionally, the touch operation is a dragging operation, and the responding module is specifically configured to make the team-forming control move to an end point position of the dragging operation based on a dragging track of the dragging operation, in response to the dragging operation on the team-forming control.

Optionally, the touch operation includes a first touch operation and a second touch operation, and the responding module is specifically configured to determine an object at a target position as the target object in response to the first touch operation on the team-forming control and the second touch operation on the target position.

Optionally, in this device, the above target object includes: a control, a scene object, and a character object.

Optionally, the triggering module is specifically configured to display a team-forming confirmation sub-interface on the graphical user interface, wherein the team-forming confirmation sub-interface at least includes: the target team-forming mode; and trigger a team-forming instruction corresponding to the target team-forming mode in response to a confirmation operation on the team-forming confirmation sub-interface.

Optionally, the team-forming confirmation sub-interface further includes a team-forming option control, and the triggering module is further configured to send preset team-forming information corresponding to the team-forming option control by means of instant communication, after establishing a team corresponding to the target team-forming mode, in response to a selection operation on the team-forming option control.

Optionally, the determining module is specifically configured to acquire a pre-configured mapping relationship data table, wherein the mapping relationship data table reflects a mapping relationship between identification information and a team-forming mode of an object; and determine the target team-forming mode according to the identification information about the target object, based on the mapping relationship between the identification information and the team-forming mode of the object in the mapping relationship data table.

Optionally, the identification information includes: text identification, and the mapping relationship data table includes a first mapping relationship; and the determining module is specifically configured to acquire the first mapping relationship, wherein the first mapping relationship is used to indicate the mapping relationship between the text identification and the team-forming mode of the object; and take a team-forming mode corresponding to the text identification of the target object as the target team-forming mode, based on the first mapping relationship.

Optionally, the responding module is further configured to establish the first mapping relationship between the text identification and the team-forming mode of the object in response to an association configuration operation.

Optionally, the identification information includes: image identification, and the mapping relationship data table includes a second mapping relationship; and the determining module is specifically configured to acquire the second mapping relationship, wherein the second mapping relationship is used to indicate the mapping relationship between the image identification and the team-forming mode of the object; and take a team-forming mode corresponding to the image identification of the target object as the target team-forming mode, based on the second mapping relationship.

Optionally, the responding module is further configured to establish the second mapping relationship between the image identification and the team-forming mode of the object in response to an association configuration operation.

In another aspect of the embodiments, the present disclosure provides computer equipment, including a memory and a processor, wherein the memory stores a computer program executable on the processor, and when the processor executes the computer program, the steps of the above in-game team-forming method are implemented.

In another aspect of the embodiments, the present disclosure provides a computer-readable storage medium, wherein the storage medium stores a computer program, and when the computer program is executed by a processor, the steps of the above in-game team-forming method are implemented.

The embodiments of the present disclosure include the following beneficial effects.

In the in-game team-forming method, device, equipment, and storage medium provided in the embodiments of the present disclosure, the target object can be determined according to the touch operation in response to the touch operation on the team-forming control; the target team-forming mode corresponding to the target object is determined based on the mapping relationship between the object and the team-forming mode, wherein the target team-forming mode at least includes the team-forming task; and the team-forming instruction corresponding to the target team-forming mode is triggered according to the target team-forming mode. In the above, the player determines the target object through the touch operation on the team-forming control, and further can determine the required target team-forming mode according to the mapping relationship between the target object and the team-forming mode, thus triggering the team-forming instruction for the target team-forming mode and establishing the corresponding team, which can simplify the flow required for forming a team, reduce the team-forming complexity, and further can improve the team-forming efficiency.

### BRIEF DESCRIPTION OF DRAWINGS

In order to more clearly illustrate technical solutions of embodiments of the present disclosure, drawings which need to be used in the embodiments will be introduced briefly below, and it should be understood that the drawings below merely show some embodiments of the present disclosure, therefore, they should not be considered as limitation on the scope, and those ordinarily skilled in the art still could obtain other relevant drawings according to these drawings, without using any creative efforts.

FIG. 1 is a schematic diagram displaying a graphical user interface provided in an embodiment of the present disclosure;

FIG. 2 is a first schematic flowchart of an in-game team-forming method provided in an embodiment of the present disclosure;

FIG. 3 is a first interface schematic diagram of a touch operation on the graphical user interface provided in an embodiment of the present disclosure;

FIG. 4 is a second interface schematic diagram of the touch operation on the graphical user interface provided in an embodiment of the present disclosure;

FIG. 5 is a third interface schematic diagram of the touch operation on the graphical user interface provided in an embodiment of the present disclosure;

FIG. 6 is a second schematic flowchart of the in-game team-forming method provided in an embodiment of the present disclosure;

FIG. 7 is a schematic interface diagram of a team-forming confirmation sub-interface on the graphical user interface provided in an embodiment of the present disclosure;

FIG. 8 is a third schematic flowchart of the in-game team-forming method provided in an embodiment of the present disclosure;

FIG. 9 is a fourth schematic flowchart of the in-game team-forming method provided in an embodiment of the present disclosure;

FIG. 10 is a fifth schematic flowchart of the in-game team-forming method provided in an embodiment of the present disclosure;

FIG. 11 is a structural schematic diagram of an in-game team-forming device provided in an embodiment of the present disclosure; and

FIG. 12 is a structural schematic diagram of computer equipment provided in an embodiment of the present disclosure.

### DETAILED DESCRIPTION OF EMBODIMENTS

In order to make objectives, technical solutions, and advantages of the embodiments of the present disclosure clearer, the technical solutions in the embodiments of the present disclosure will be described clearly and completely below in conjunction with drawings in the embodiments of the present disclosure, and apparently, the embodiments described are some but not all embodiments of the present disclosure. Generally, components in the embodiments of the present disclosure, as described and shown in the drawings herein, may be arranged and designed in various different configurations.

Therefore, the detailed description below of the embodiments of the present disclosure provided in the drawings is not intended to limit the scope of the present disclosure claimed, but merely illustrates chosen embodiments of the present disclosure. All of other embodiments obtained by those ordinarily skilled in the art based on the embodiments in the present disclosure without using any creative efforts shall fall within the scope of protection of the present disclosure.

It should be noted that similar reference signs and letters represent similar items in the following drawings, therefore, once a certain item is defined in one drawing, it is not needed to be further defined or explained in subsequent drawings.

In the description of the present disclosure, it should be noted that terms such as “first”, “second”, and “third” are used only for distinguishing the description, and should not be understood as indicating or implying importance in the relativity.

An in-game team-forming method in one of the embodiments of the present disclosure can run on a terminal device or a server. In the above, the terminal device may be a local terminal device. When the in-game team-forming method runs on a server, this method can be realized and executed based on a cloud interaction system, wherein the cloud interaction system includes the server and a client device.

In an optional embodiment, the cloud interaction system may run various cloud applications, for example, a cloud game. Taking the cloud game as an example, the cloud game refers to a cloud computation-based game mode. In a running mode of the cloud game, a running subject of a game program and a game screen presentation subject are separated, storage and running of the game display method are completed on a cloud game server, a client device functions to receive and transmit data and present the game screen, for example, the client device may be a display device with a data transmission function close to a user side, e.g., a mobile terminal, a television, a computer, a handheld computer, etc. However, the terminal device that performs information processing is the cloud game server in the cloud. When playing, the player operates the client device to send an operation instruction to the cloud game server, the cloud game server runs the game according to the operation instruction, encodes and compresses data such as the game screen, and returns the same to the client device via network, and finally, the client device decodes and outputs the game screen.

In an optional embodiment, the terminal device may be a local terminal device. Taking a game as an example, the local terminal device stores a game program and is configured to present a game screen. The local terminal device is configured to interact with a player via a graphical user interface, i.e., conventionally downloading and installing the game program and running the same through electronic equipment. The local terminal device may provide the graphical user interface to the player in various manners, for example, the graphical user interface may be rendered on a display screen of the terminal, or may be provided to the player by means of holographical projection. For example, the local terminal device may include a display screen and a processor, wherein the display screen is configured to present the graphical user interface, the graphical user interface includes the game screen, and the processor is configured to run the game, generate the graphical user interface, and control the display of the graphical user interface on the display screen.

In a possible embodiment, an example of the present disclosure provides an in-game team-forming method, and the graphical user interface is provided by a first terminal device, wherein the first terminal device may be the local terminal device mentioned in the preceding, and also may be the client device in the cloud interaction system mentioned in the preceding.

Specific schematic interfaces of the graphical user interface provided in the embodiments of the present disclosure and contents included in the interfaces are explained in detail below.

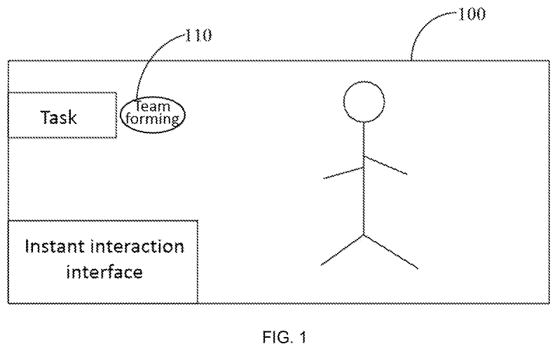

FIG. 1 is a schematic diagram displaying the graphical user interface provided in an embodiment of the present disclosure. Referring to FIG. 1, a graphical user interface 100 may be an interface displayed on a terminal device, wherein the terminal device may be any type of computer equipment, such as a computer, a mobile phone, a tablet computer, a game console, or dedicated electronic equipment, which is not specifically limited herein.

Optionally, the graphical user interface 100 may be displayed in the terminal device, and specifically may be displayed by application software in the terminal device, such as interactive software and game software.

Optionally, picture information such as an image and a text can be displayed on the graphical user interface 100, a control can also be provided on the graphical user interface, and a user (a player) can realize interaction with the graphical user interface 100 by triggering this control.

Alternatively, in an embodiment of the present disclosure, at least one team-forming control 110 can be provided on the graphical user interface 100, and the team-forming control 110 may be specifically displayed on the graphical user interface 100 in the form of an icon, a text, or the like.

A specific implementation process of the in-game team-forming method provided in an embodiment of the present disclosure is explained below based on specific layout of the above graphical user interface.

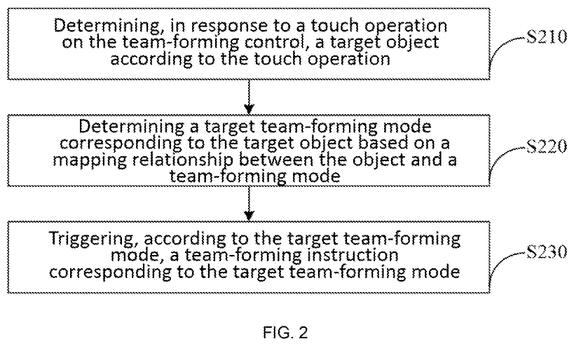

FIG. 2 is a first schematic flowchart of the in-game team-forming method provided in an embodiment of the present disclosure. Referring to FIG. 2, the method includes the following steps.

S210: determining, in response to a touch operation on the team-forming control, a target object according to the touch operation.

Optionally, an execution subject of this method may be the foregoing terminal device, and the touch operation specifically may be a click on the team-forming control by a user (a player), for example, single-click, double-click, and long-press, or may also be an operation such as dragging on the team-forming control, which is not specifically limited herein, as long as interaction of the team-forming control can be triggered by the user.

Optionally, the object specifically may be another control, scene object, character object, and the like, for example, a control for triggering entry of a certain copy in the game, a control for entering a certain task interface, an entrance of a certain playing method in the game scene, and a model of a certain monster in the game scene. The target object may be any one or more of the foregoing objects, which is not limited herein.

Optionally, the terminal device can determine the target object according to the touch operation in response to the touch operation of the user on the team-forming control.

S220: determining a target team-forming mode corresponding to the target object based on a mapping relationship between the object and a team-forming mode.

In the above, the target team-forming mode at least includes a team-forming task.

Optionally, the mapping relationship between the object and the team-forming mode can be pre-stored in the terminal device, or the terminal device can acquire the mapping relationship by other devices (such as a server) in communication with the terminal device, and can be specifically used to indicate a corresponding relationship between the object and the team-forming mode. For example, one object may be corresponding to one team-forming mode.

Optionally, the target team-forming mode may be a team-forming mode of a team to be established, wherein the team-forming mode may be one of a plurality of preset modes of multiple team games. The team-forming task may be a task of establishing the target team-forming mode.

Optionally, after the target object is determined, the target team-forming mode corresponding to the target object can be determined according to the mapping relationship between the object and the team-forming mode.

S230: triggering, according to the target team-forming mode, a team-forming instruction corresponding to the target team-forming mode.

Optionally, the team-forming instruction may be an instruction for forming a team initiated by the terminal device, and after the terminal device sends this instruction to the server, a corresponding team can be established.

Optionally, a type of the team to be established can be specifically determined according to the team-forming task included in the target team-forming mode, and further a corresponding team-forming instruction is generated.

In the in-game team-forming method provided in the embodiments of the present disclosure, the target object is determined according to the touch operation in response to the touch operation on the team-forming control; the target team-forming mode corresponding to the target object is determined based on the mapping relationship between the object and the team-forming mode, wherein the target team-forming mode at least includes a team-forming task; and the team-forming instruction corresponding to the target team-forming mode is triggered according to the target team-forming mode. In the above, the player determines the target object through the touch operation on the team-forming control, and further can determine the required target team-forming mode according to the mapping relationship between the target object and the team-forming mode, thus triggering the team-forming instruction for the target team-forming mode and establishing the corresponding team, which can simplify the flow required for forming a team, reduce the team-forming complexity, and further can improve the team-forming efficiency.

Specific contents displayed on the graphical user interface when operating on the graphical user interface are explained in detail below.

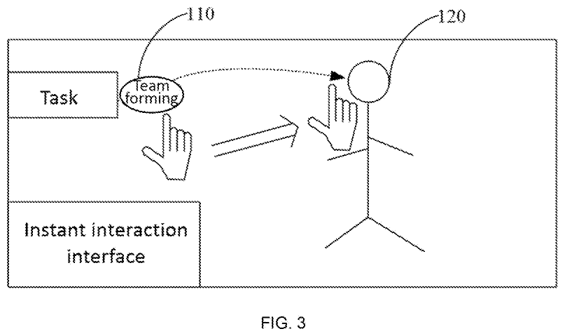

FIG. 3 is a first interface schematic diagram of the touch operation on the graphical user interface provided in an embodiment of the present disclosure. Referring to FIG. 3, when the touch operation is a dragging operation, the step of determining a target object according to the touch operation specifically may be determining an object at an end point position of the dragging operation as a target object 120.

Optionally, the touch operation specifically may be a dragging operation, and the dragging operation specifically may be a process that the user triggers at the team-forming control and keeps the contact state of triggering to drag to the end point position so as to complete the triggering. A game scene or an interaction interface may be displayed on the graphical user interface, the game scene or the interaction interface may include a plurality of objects, and an object at the end point position of the dragging operation can be determined as the target object 120.

The target object 120 shown in FIG. 3 is an object dragged to the end point position by the user by performing the dragging operation from the team-forming control 110. In FIG. 3, the target object being a character object is taken as an example.

Other specific contents displayed on the graphical user interface when operating on the graphical user interface are specifically explained below.

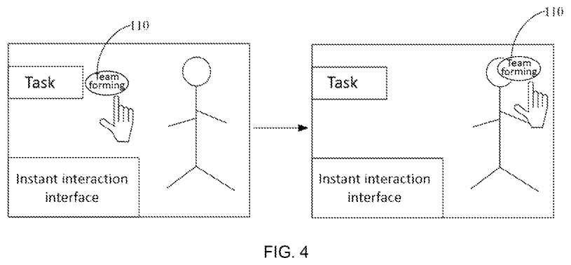

FIG. 4 is a second interface schematic diagram of the touch operation on the graphical user interface provided in an embodiment of the present disclosure. Referring to FIG. 4, when the touch operation is a dragging operation, the preceding step of determining a target object according to the touch operation may be making the team-forming control move to an end point position of the dragging operation based on a dragging track of the dragging operation, in response to the dragging operation on the team-forming control.

Optionally, when the touch operation is the dragging operation, the team-forming control 110 can be controlled to move, and specifically, the team-forming control 110 can be moved from an initial position to the end point position of the dragging operation according to the dragging track of the dragging operation of the user. In FIG. 4, the target object being a character object is taken as an example.

In the in-game team-forming method provided in the embodiments of the present disclosure, the team-forming control can be made to move to the end point position of the dragging operation based on the dragging track of the dragging operation in response to the dragging operation on the team-forming control. In the above, the corresponding dragging track can be displayed on the graphical user interface, so that the user can more intuitively acquire a process of performing the dragging operation and a dragging result, thus improving the user's sense of operation experience. Moreover, the team forming is implemented by means of dragging, without redundant controls additionally provided, which can reduce the pressure caused by an excessive number of components in the game.

Further specific contents displayed on the graphical user interface when operating on the graphical user interface are specifically explained below.

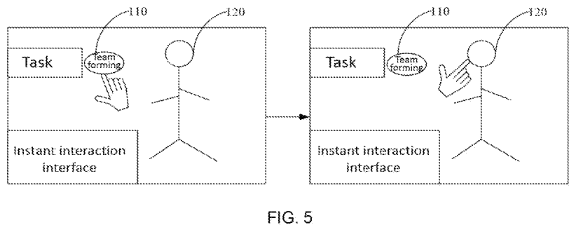

FIG. 5 is a third interface schematic diagram of the touch operation on the graphical user interface provided in an embodiment of the present disclosure. Referring to FIG. 5, the touch operation includes a first touch operation and a second touch operation, and the step of determining, in response to a touch operation on the team-forming control, a target object according to the touch operation includes: determining an object at a target position as the target object in response to the first touch operation on the team-forming control and the second touch operation on the target position.

Optionally, the first touch point of the touch operation is located on the team-forming control, i.e., the touch operation of the user on the team-forming control 110; and the second touch point of the touch operation is located on the target object, i.e., the touch operation of the user on the target object 120.

Optionally, the terminal device can determine the object at the target position as the target object 120 in response to the user's first touch operation on the first touch point and the second touch operation on the second touch point on the graphical user interface (alternatively, the second touch operation on the first touch point and the first touch operation on the second touch point, in which a specific touch sequence is not specifically limited herein).

Optionally, the above touch operations specifically may be click operations (for example, single-click, long-press or double-click, which is not limited herein). In FIG. 5, the target object being a character object is taken as an example.

In the in-game team-forming method provided in the embodiments of the present disclosure, the target object can be determined in a plurality of feasible manners as shown in FIG. 3 or FIG. 5. Specifically, the object at the end point position of the dragging operation can be determined as the target object, or in response to the first touch operation on the team-forming control and the second touch operation on the target position, the object at the target position can be determined as the target object. Thus, the target object can be determined in various manners, improving the user's operation adaptability, and thereby improving the user's sense of operation experience.

Another specific implementation process of the in-game team-forming method provided in the embodiments of the present disclosure is explained below.

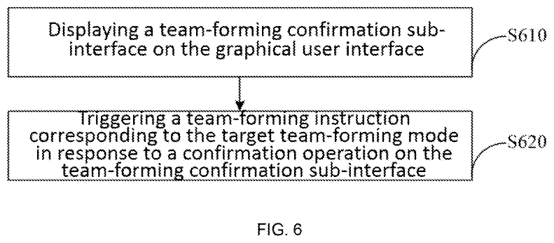

FIG. 6 is a second schematic flowchart of the in-game team-forming method provided in an embodiment of the present disclosure. Referring to FIG. 6, the step of triggering, according to the target team-forming mode, a team-forming instruction corresponding to the target team-forming mode includes the following steps.

S610: displaying a team-forming confirmation sub-interface on the graphical user interface.

In the above, the team-forming confirmation sub-interface at least includes: a target team-forming mode.

Optionally, the team-forming confirmation sub-interface may be a popup interface set on the graphical user interface, and after the target team-forming mode is determined, the team-forming confirmation sub-interface can be displayed on the graphical user interface.

Optionally, the target team-forming mode can be displayed on the team-forming confirmation sub-interface, and specifically can be displayed in a manner that can be used to indicate this target team-forming mode such as a name, an icon or others of the target team-forming mode, which is not specifically limited herein.

Optionally, if the target team-forming mode further includes a sub-mode, corresponding information about this sub-mode also can be displayed on the team-forming confirmation sub-interface. For example, the target team-forming mode is named as “Abyss and Giant Hole”, multiple sub-modes such as “simple” and “hard” are further included in this mode, and the content finally displayed may be “Abyss and Giant Hole-hard”.

The above is only one example, and adjustment can be adaptively made according to actual game requirements in a process of actually performing the display, and is not limited to the above displaying manner.

S620: triggering a team-forming instruction corresponding to the target team-forming mode in response to a confirmation operation on the team-forming confirmation sub-interface.

Optionally, a confirmation control also may be provided on the team-forming confirmation sub-interface, which may trigger the team-forming instruction corresponding to the target team-forming mode in response to a triggering operation of the user; and alternatively, the confirmation control may not be provided, and when the user does not perform an operation within a certain preset time, for example, 3 seconds, the team-forming instruction corresponding to the target team-forming mode can be triggered.

Optionally, a cancellation control also may be provided on the team-forming confirmation sub-interface, and the team-forming can be cancelled in response to a triggering operation of the user on the cancellation control.

In the in-game team-forming method provided in the embodiments of the present disclosure, the team-forming confirmation sub-interface can be displayed on the graphical user interface, and the team-forming instruction corresponding to the target team-forming mode can be triggered in response to the confirmation operation on the team-forming confirmation sub-interface. In the above, the user can be made to further confirm the team forming through the team-forming confirmation sub-interface, thus preventing the team forming caused by a mistaken click of the user or other factors. Moreover, displaying relevant information about the target team-forming mode on the team-forming confirmation sub-interface also can prevent an error in the target team-forming mode due to misoperation of the user, thus the user's sense of game experience can be improved.

Display of an interface for sending preset team-forming information in the in-game team-forming method provided in the embodiments of the present disclosure is explained below.

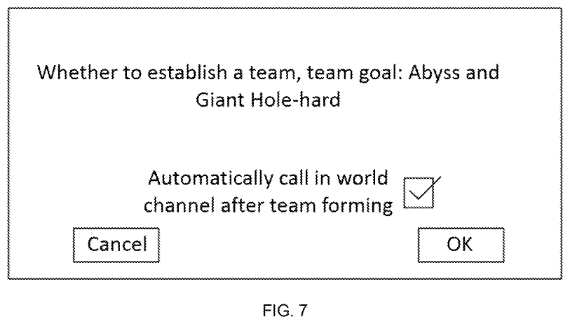

FIG. 7 is an interface schematic diagram of the team-forming confirmation sub-interface on the graphical user interface provided in an embodiment of the present disclosure. Referring to FIG. 7, the team-forming confirmation sub-interface on the graphical user interface may include the target team-forming mode, the confirmation control, the cancellation control and so on explained in FIG. 6. In addition, a team-forming option control also may be included.

Correspondingly, the method further includes: sending preset team-forming information corresponding to the team-forming option control by means of instant communication, after establishing a team corresponding to the target team-forming mode, in response to a selection operation on the team-forming option control.

Optionally, the team-forming option control may be a control displayed on the team-forming confirmation sub-interface, for example, the team-forming option control may be in the form of a text, such as “whether to send preset team-forming information” or “automatically call in world channel after team forming” (as shown in FIG. 7), and the user can select “Yes” or “No” through options associated with the text; if “Yes” is selected, the preset team-forming information corresponding to the team-forming option control can be sent by instant communication; and if “No” is selected, the preset team-forming information may not be sent.

Optionally, the interface for sending the preset team-forming information may be, for example, a chat interface on a game interface (possibly an all-in-one chat interface, an individual chat interface, or a chat interface under an organization formed by players within a specific range, which is not specifically limited herein).

The preset team-forming information can be sent by means of instant communication, wherein the preset team-forming information can be composed of preset words, pictures, links, etc. For example, it may be “I have established a team Abyss and Giant Hole-hard, [Come to join us]”, where “I have established a team Abyss and Giant Hole-hard” may be preset text information, “[Come to join us]” may be preset link information, and other players may enter the corresponding team by clicking the link.

It should be noted that, the above content of the preset team-forming information is merely an example, and in practical application, corresponding settings may be performed according to the user's practical requirements, which is not limited thereto.

A further specific implementation process of the in-game team-forming method provided in the embodiments of the present disclosure is specifically explained below.

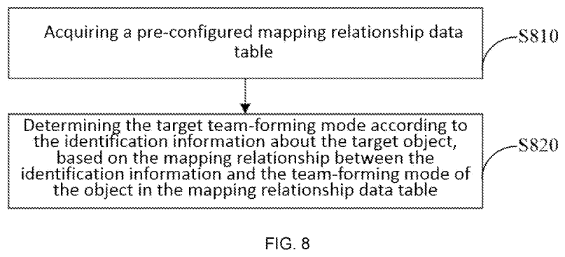

FIG. 8 is a third schematic flowchart of the in-game team-forming method provided in an embodiment of the present disclosure. Referring to FIG. 8, the step of determining a target team-forming mode corresponding to the target object based on a mapping relationship between the object and a team-forming mode includes the following steps.

S810: acquiring a pre-configured mapping relationship data table.

In the above, the mapping relationship data table reflects a mapping relationship between identification information and a team-forming mode of an object.

Optionally, the pre-configured mapping relationship data table may be a relevant record file stored in the terminal device, or also may be a relevant record file stored in the server that can establish a communication interaction relationship with the terminal device.

When the pre-configured mapping relationship data table needs to be acquired, if the mapping relationship data table is stored in the terminal device, the mapping relationship data table can be invoked; and if the mapping relationship data table is stored in the server, the mapping relationship data table can be acquired by sending a request to the server.

Optionally, the mapping relationship data table can record mapping relationships between identification information and team-forming modes of multiple objects. For example, identification information about a certain task control on the graphical user interface is “Perform one round of combat in Abyss and Giant Hole mode”, this task control is an object, and the team-forming mode corresponding to this object may be “Abyss and Giant Hole” mode; for another example, a model of a monster or a model of a scene entrance is set in a game scene on the interface, the model of the monster or the model of the scene entrance is an object, and corresponding identification information thereof is an image displayed on the interface, etc. If the model of the monster is a model of a monster in “Abyss and Giant Hole”, or the model of the scene entrance is a model of a scene entrance of “Abyss and Giant Hole”, the team-forming mode corresponding to this object also may be “Abyss and Giant Hole” mode.

It should be noted that the identification information specifically may be relevant information for representing the above objects in the form of text, image, code, or the like, which is not limited in a specific existing form herein.

S820: determining the target team-forming mode according to the identification information about the target object, based on the mapping relationship between the identification information and the team-forming mode of the object in the mapping relationship data table.

Optionally, the mapping relationship data table stores therein the mapping relationships between the identification information and the team-forming modes of multiple objects, and these mapping relationships can be configured in advance according to practical application requirements.

After the target object is determined, a corresponding query can be performed in the mapping relationship data table according to the identification information about the target object, so as to determine the target team-forming mode corresponding to the identification information about the target object.

In the in-game team-forming method provided in the embodiments of the present disclosure, the pre-configured mapping relationship data table can be acquired; and the target team-forming mode can be determined according to the identification information about the target object, based on the mapping relationship between the identification information and the team-forming mode of the object in the mapping relationship data table. In the above, mapping query for the identification information and the team-forming mode of the object can be achieved more quickly through the pre-configured mapping relationship data table, thus the efficiency of determining the target team-forming mode is improved, and further, the efficiency of forming a team by the player can be improved.

An optional specific implementation process of the above in-game team-forming method when the identification information is text identification is specifically explained below.

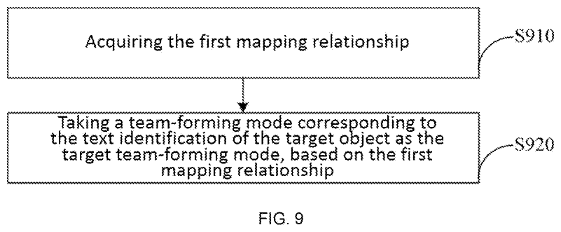

FIG. 9 is a fourth schematic flowchart of the in-game team-forming method provided in an embodiment of the present disclosure. Referring to FIG. 9, the identification information includes: text identification, and the mapping relationship data table includes a first mapping relationship; and the step of determining the target team-forming mode according to the identification information about the target object, based on the mapping relationship between the identification information and the team-forming mode of the object in the mapping relationship data table includes the following steps.

S910: acquiring the first mapping relationship.

In the above, the first mapping relationship is used to indicate the mapping relationship between the text identification and the team-forming mode of the object.

Optionally, the first mapping relationship may include mapping relationships between text identifications and team-forming modes of multiple objects, and the text identification may be identification information displayed in a text form.

Exemplarily, when the object is a certain control, the control may correspondingly have relevant text information. For example, as for a task “Pass Abyss and Giant Hole-hard’, corresponding text information thereof may include task goal, task progress, task explanation, and so on, wherein the task goal can be “Pass Abyss and Giant Hole-hard”; the task progress can display completion progress in the form of numerical ratio, for example, “0/1” can indicate that the task needs to be perform once and has been completed 0 times currently, and when the current number of completion times is greater than the number of times that the task needs to be completed, the task is completed; and the task explanation can be text explanation for the task, such as “Kill all demons in this level”. The above text information can be used as text identification of this control.

S920: taking a team-forming mode corresponding to the text identification of the target object as the target team-forming mode, based on the first mapping relationship.

Optionally, after the text identification of the target object is determined, the target team-forming mode corresponding to the target object can be determined based on the mapping relationship between the text identification and the team-forming mode of the object.

Optionally, before acquiring the first mapping relationship, the method further includes: establishing the first mapping relationship between the text identification and the team-forming mode of the object in response to an association configuration operation.

Optionally, the above first mapping relationship may be a relationship configured in advance, may be a relationship generated according to a preset rule, and also may be a relationship associated and configured manually, which is not specifically limited herein.

An optional specific implementation process of the above in-game team-forming method when the identification information is image identification is specifically explained below.

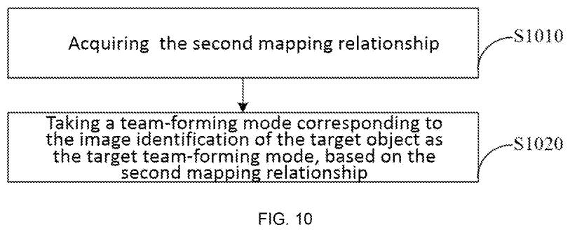

FIG. 10 is a fifth schematic flowchart of the in-game team-forming method provided in an embodiment of the present disclosure. Referring to FIG. 10, the identification information includes: an image identification, and the mapping relationship data table includes a second mapping relationship; and the step of determining the target team-forming mode according to the identification information about the target object, based on the mapping relationship between the identification information and the team-forming mode of the object in the mapping relationship data table includes the following steps.

S1010: acquiring the second mapping relationship.

In the above, the second mapping relationship is used to indicate the mapping relationship between the image identification and the team-forming mode of the object.

Optionally, the second mapping relationship may include mapping relationships between image identifications and team-forming modes of multiple objects, and the image identification may be identification information displayed in a form such as 3D models and pictures.

Exemplarily, when the object is a certain scene object or character object, the control may correspondingly have relevant image information. For example, in the game mode of “Abyss and Giant Hole”, an entrance of the scene, a monster in the scene and the like may be included, and a 3D model or picture corresponding to the entrance of the scene and a 3D model or picture corresponding to the monster in the scene may all be used as the above image identification.

S1020: taking a team-forming mode corresponding to the image identification of the target object as the target team-forming mode, based on the second mapping relationship.

Optionally, after the image identification of the target object is determined, the target team-forming mode corresponding to the target object can be determined based on the mapping relationship between the image identification and the team-forming mode of the object.

Optionally, before acquiring the second mapping relationship, the method further includes: establishing the second mapping relationship between the image identification and the team-forming mode of the object in response to an association configuration operation.

Optionally, the above second mapping relationship may be a relationship configured in advance, may be a relationship generated according to a preset rule, and also may be a relationship associated and configured manually, which is not specifically limited herein.

In the in-game team-forming method provided in the embodiments of the present disclosure, the first mapping relationship can be acquired, and the team-forming mode corresponding to the text identification of the target object is taken as the target team-forming mode, based on the first mapping relationship; alternatively, the second mapping relationship can be acquired, and the team-forming mode corresponding to the image identification of the target object is taken as the target team-forming mode, based on the second mapping relationship. In the above, the user can determine the target team-forming mode more quickly according to his/her own operation habits or relevant identification information present in the scene/interface, thus the time for the user to establish a team is saved, and further the user's sense of game experience can be improved.

Corresponding device, equipment, storage medium, etc. for executing the in-game team-forming method provided in the present disclosure are illustrated below. See the above-mentioned for specific implementation processes and technical effects thereof, and details will not be repeated herein again.

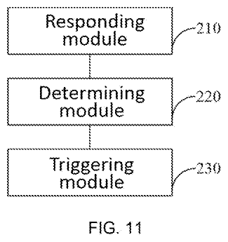

FIG. 11 is a structural schematic diagram of an in-game team-forming device provided in an embodiment of the present disclosure. Referring to FIG. 11, the device includes: a responding module 210, a determining module 220, and a triggering module 230;
the responding module 210 is configured to determine, in response to a touch operation on the team-forming control, a target object according to the touch operation;
the determining module 220 is configured to determine a target team-forming mode corresponding to the target object based on a mapping relationship between the target object and a team-forming mode, wherein the target team-forming mode at least includes a team-forming task; and
the triggering module 230 is configured to trigger, according to the target team-forming mode, a team-forming instruction corresponding to the target team-forming mode.

Optionally, in the device, the first touch point of the above touch operation is located on the team-forming control, and the second touch point of the touch operation is located on the target object.

Optionally, the touch operation is a dragging operation, and the responding module 210 is specifically configured to determine an object at an end point position of the dragging operation as a target object.

Optionally, the touch operation is a dragging operation, and the responding module 210 is specifically configured to make the team-forming control move to an end point position of the dragging operation based on a dragging track of the dragging operation, in response to the dragging operation on the team-forming control.

Optionally, the touch operation includes a first touch operation and a second touch operation, and the responding module 210 is specifically configured to determine an object at a target position as the target object in response to the first touch operation on the team-forming control and the second touch operation on the target position.

Optionally, in the device, the above target object includes: a control, a scene object, and a character object.

Optionally, the triggering module 230 is specifically configured to display a team-forming confirmation sub-interface on the graphical user interface, wherein the team-forming confirmation sub-interface at least includes: a target team-forming mode; and trigger a team-forming instruction corresponding to the target team-forming mode in response to a confirmation operation on the team-forming confirmation sub-interface.

Optionally, the team-forming confirmation sub-interface further includes a team-forming option control, and the triggering module 230 is further configured to send preset team-forming information corresponding to the team-forming option control by means of instant communication, after establishing a team corresponding to the target team-forming mode, in response to a selection operation on the team-forming option control.

Optionally, the determining module 220 is specifically configured to acquire a pre-configured mapping relationship data table, wherein the mapping relationship data table reflects a mapping relationship between identification information and a team-forming mode of an object; and determine the target team-forming mode according to the identification information about the target object, based on the mapping relationship between the identification information and the team-forming mode of the object in the mapping relationship data table.

Optionally, the identification information includes: text identification, and the mapping relationship data table includes a first mapping relationship; and the determining module 220 is specifically configured to acquire the first mapping relationship, wherein the first mapping relationship is used to indicate the mapping relationship between the text identification and the team-forming mode of the object; and take a team-forming mode corresponding to the text identification of the target object as the target team-forming mode, based on the first mapping relationship.

Optionally, the responding module 210 is further configured to establish the first mapping relationship between the text identification and the team-forming mode of the object in response to an association configuration operation.

Optionally, the identification information includes: an image identification, and the mapping relationship data table includes a second mapping relationship; the determining module 220 is specifically configured to acquire the second mapping relationship, wherein the second mapping relationship is used to indicate the mapping relationship between the image identification and the team-forming mode of the object; and take a team-forming mode corresponding to the image identification of the target object as the target team-forming mode, based on the second mapping relationship.

Optionally, the responding module 210 is further configured to establish the second mapping relationship between the image identification and the team-forming mode of the object in response to an association configuration operation.

The above device is configured to execute the method provided in the foregoing embodiments, and has similar implementation principle and technical effects, which are not described herein again.

These above modules may be one or more integrated circuits configured to implement the above method, for example, one or more application specific integrated circuits (ASIC for short), or one or more digital signal processors, or one or more field programmable gate arrays (FPGA for short), etc. For another example, when a certain module above is implemented in a form of invoking a program code by a processing element, the processing element may be a general purpose processor, for example, a central processing unit (CPU for short) or other processors that can invoke the program code. For another example, these modules may be integrated together and implemented in the form of a system-on-a-chip (SOC for short).

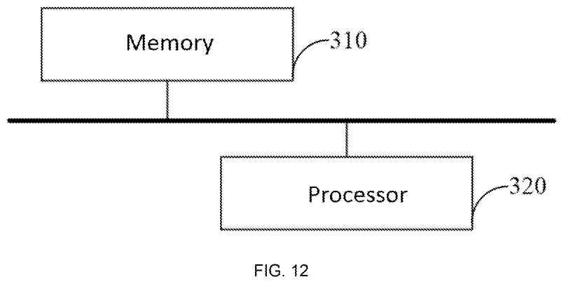

FIG. 12 is a structural schematic diagram of computer equipment provided in an embodiment of the present disclosure. As shown in FIG. 12, the computer equipment includes a memory 310 and a processor 320, the memory 310 stores a computer program executable on the processor 320, and when executing the computer program, the processor 320 implements a method including steps of:
determining, in response to a touch operation on a team-forming control, a target object according to the touch operation;
determining a target team-forming mode corresponding to the target object based on a mapping relationship between the object and a team-forming mode, wherein the target team-forming mode at least includes a team-forming task; and
triggering, according to the target team-forming mode, a team-forming instruction corresponding to the target team-forming mode.

Optionally, the first touch point of the touch operation is located on the team-forming control, and the second touch point of the touch operation is located on the target object.

Optionally, the touch operation is a dragging operation, and the step of determining a target object according to the touch operation includes:
determining an object at an end point position of the dragging operation as the target object.

Optionally, the touch operation is a dragging operation, and the step of determining a target object according to the touch operation includes:
making the team-forming control move to the end point position of the dragging operation based on a dragging track of the dragging operation, in response to the dragging operation on the team-forming control.

Optionally, the touch operation includes a first touch operation and a second touch operation, and the step of determining, in response to the touch operation on the team-forming control, a target object according to the touch operation includes:
determining an object at a target position as the target object in response to the first touch operation on the team-forming control and the second touch operation on the target position.

Optionally, the target object includes: a control, a scene object, and a character object.

Optionally, the step of triggering, according to the target team-forming mode, a team-forming instruction corresponding to the target team-forming mode includes:
displaying a team-forming confirmation sub-interface on the graphical user interface, wherein the team-forming confirmation sub-interface at least includes: the target team-forming mode; and
triggering a team-forming instruction corresponding to the target team-forming mode in response to a confirmation operation on the team-forming confirmation sub-interface.

Optionally, the team-forming confirmation sub-interface further includes a team-forming option control, and this method further includes:
sending preset team-forming information corresponding to the team-forming option control by means of instant communication, after establishing a team corresponding to the target team-forming mode, in response to a selection operation on the team-forming option control.

Optionally, the step of determining a target team-forming mode corresponding to the target object based on a mapping relationship between the object and a team-forming mode includes:
acquiring a pre-configured mapping relationship data table, wherein the mapping relationship data table reflects a mapping relationship between identification information and a team-forming mode of an object; and
determining the target team-forming mode according to the identification information about the target object, based on the mapping relationship between the identification information and the team-forming mode of the object in the mapping relationship data table.

Optionally, the identification information includes: text identification, and the mapping relationship data table includes a first mapping relationship; and the step of determining the target team-forming mode according to the identification information about the target object, based on the mapping relationship between the identification information and the team-forming mode of the object in the mapping relationship data table includes:
acquiring the first mapping relationship, wherein the first mapping relationship is used to indicate the mapping relationship between the text identification and the team-forming mode of the object; and
taking a team-forming mode corresponding to the text identification of the target object as the target team-forming mode, based on the first mapping relationship.

Optionally, before acquiring the first mapping relationship, the method further includes:
establishing the first mapping relationship between the text identification and the team-forming mode of the object in response to an association configuration operation.

Optionally, the identification information includes: image identification, and the mapping relationship data table includes a second mapping relationship; and the step of determining the target team-forming mode according to the identification information about the target object, based on the mapping relationship between the identification information and the team-forming mode of the object in the mapping relationship data table includes:
acquiring the second mapping relationship, wherein the second mapping relationship is used to indicate the mapping relationship between the image identification and the team-forming mode of the object; and
taking a team-forming mode corresponding to the image identification of the target object as the target team-forming mode, based on the second mapping relationship.

Optionally, before acquiring the second mapping relationship, the method further includes:
establishing the second mapping relationship between the image identification and the team-forming mode of the object in response to an association configuration operation.

The computer equipment provided in the embodiment of the present disclosure can determine the target object according to the touch operation in response to the touch operation on the team-forming control; determine the target team-forming mode corresponding to the target object based on the mapping relationship between the object and the team-forming mode, wherein the target team-forming mode at least includes the team-forming task; and trigger the team-forming instruction corresponding to the target team-forming mode according to the target team-forming mode. In the above, the player determines the target object through the touch operation on the team-forming control, and further can determine the required target team-forming mode according to the mapping relationship between the target object and the team-forming mode, thus triggering the team-forming instruction for the target team-forming mode and establishing the corresponding team, which can simplify the flow required for forming a team, reduce the team-forming complexity, and further can improve the team-forming efficiency.

In another aspect of the embodiments, the present disclosure provides a computer-readable storage medium, wherein the storage medium stores a computer program, and when the computer program is executed by a processor, a method including the following steps is realized:
determining, in response to a touch operation on a team-forming control, a target object according to the touch operation;
determining a target team-forming mode corresponding to the target object based on a mapping relationship between the object and a team-forming mode, wherein the target team-forming mode at least includes a team-forming task; and
triggering, according to the target team-forming mode, a team-forming instruction corresponding to the target team-forming mode.

Optionally, the first touch point of the touch operation is located on the team-forming control, and the second touch point of the touch operation is located on the target object.

Optionally, the touch operation is a dragging operation, and the step of determining a target object according to the touch operation includes:
determining an object at an end point position of the dragging operation as the target object.

Optionally, the touch operation is a dragging operation, and the step of determining a target object according to the touch operation includes:
making the team-forming control move to the end point position of the dragging operation based on a dragging track of the dragging operation, in response to the dragging operation on the team-forming control.

Optionally, the touch operation includes a first touch operation and a second touch operation, and the step of determining, in response to the touch operation on the team-forming control, a target object according to the touch operation includes:
determining an object at a target position as the target object in response to the first touch operation on the team-forming control and the second touch operation on the target position.

Optionally, the target object includes: a control, a scene object, and a character object.

Optionally, the step of triggering, according to the target team-forming mode, a team-forming instruction corresponding to the target team-forming mode includes:
displaying a team-forming confirmation sub-interface on the graphical user interface, wherein the team-forming confirmation sub-interface at least includes: the target team-forming mode; and
triggering a team-forming instruction corresponding to the target team-forming mode in response to a confirmation operation on the team-forming confirmation sub-interface.

Optionally, the team-forming confirmation sub-interface further includes a team-forming option control, and this method further includes:
sending preset team-forming information corresponding to the team-forming option control by means of instant communication, after establishing a team corresponding to the target team-forming mode, in response to a selection operation on the team-forming option control.

Optionally, the step of determining a target team-forming mode corresponding to the target object based on a mapping relationship between the object and a team-forming mode includes:
acquiring a pre-configured mapping relationship data table, wherein the mapping relationship data table reflects a mapping relationship between identification information and a team-forming mode of an object; and
determining the target team-forming mode according to the identification information about the target object, based on the mapping relationship between the identification information and the team-forming mode of the object in the mapping relationship data table.

Optionally, the identification information includes: text identification, and the mapping relationship data table includes a first mapping relationship; and the step of determining the target team-forming mode according to the identification information about the target object, based on the mapping relationship between the identification information and the team-forming mode of the object in the mapping relationship data table includes:
acquiring the first mapping relationship, wherein the first mapping relationship is used to indicate the mapping relationship between the text identification and the team-forming mode of the object; and
taking a team-forming mode corresponding to the text identification of the target object as the target team-forming mode, based on the first mapping relationship.

Optionally, before acquiring the first mapping relationship, the method further includes:
establishing the first mapping relationship between the text identification and the team-forming mode of the object in response to an association configuration operation.

Optionally, the identification information includes: image identification, and the mapping relationship data table includes a second mapping relationship; and the step of determining the target team-forming mode according to the identification information about the target object, based on the mapping relationship between the identification information and the team-forming mode of the object in the mapping relationship data table includes:
acquiring the second mapping relationship, wherein the second mapping relationship is used to indicate the mapping relationship between the image identification and the team-forming mode of the object; and
taking a team-forming mode corresponding to the image identification of the target object as the target team-forming mode, based on the second mapping relationship.

Optionally, before acquiring the second mapping relationship, the method further includes:
establishing the second mapping relationship between the image identification and the team-forming mode of the object in response to an association configuration operation.

The computer-readable storage medium provided in the embodiment of the present disclosure can determine the target object according to the touch operation in response to the touch operation on the team-forming control; determine the target team-forming mode corresponding to the target object based on the mapping relationship between the object and the team-forming mode, wherein the target team-forming mode at least includes the team-forming task; and trigger the team-forming instruction corresponding to the target team-forming mode according to the target team-forming mode. In the above, the player determines the target object through the touch operation on the team-forming control, and further can determine the required target team-forming mode according to the mapping relationship between the target object and the team-forming mode, thus triggering the team-forming instruction for the target team-forming mode and establishing the corresponding team, which can simplify the flow required for forming a team, reduce the team-forming complexity, and further can improve the team-forming efficiency.

Optionally, the computer device may be the preceding terminal device.

In the several embodiments provided in the present disclosure, it should be understood that the device and the method disclosed may be implemented in other manners. For example, the device embodiments described in the above are merely exemplary, for example, units are merely divided according to logical functions, but they may be divided in other manners in practical implementation, for example, multiple units or components may be combined or may be integrated into another system, or some features may be omitted, or not executed. In addition, the mutual coupling, or direct coupling or communication connection shown or discussed may be implemented via indirect coupling or communication connection through some interfaces, devices or units, which may be electronic, mechanical, or in other forms.

The units described as separate parts may be or also may not be physically separated, the parts displayed as units may be or also may not be physical units, i.e., they may be located at one place, or also may be distributed on a plurality of network units. Some or all of the units may be selected according to actual needs to achieve the objectives of the solutions in the embodiments.

Besides, various functional units in various embodiments of the present disclosure can be integrated into one processing unit, or each unit also may exist in a physically independent way, or two or more units also may be integrated into one unit. The above integrated unit may be implemented in the form of hardware, or in the form of hardware plus a software functional unit.

The above integrated unit implemented in a form of software functional unit may be stored in one computer-readable storage medium. The above software functional unit is stored in one storage medium, including several instructions to make the computer equipment (which can be a personal computer, a sever or a network device, etc.) or a processor execute some of the steps of the methods of various embodiments of the present disclosure. The aforementioned storage medium includes various media that can store program codes, such as U disk, mobile hard disk, read-only memory (ROM for short), random access memory (RAM for short), magnetic disk or optical disk.

The above-mentioned are merely specific embodiments of the present disclosure, but the scope of protection of the present disclosure is not limited thereto, and any modification or substitution, easily conceivable by a person skilled in the present art within the technical scope disclosed in the present disclosure, should fall within the scope of protection of the present disclosure. Therefore, the scope of protection of the present disclosure should be determined by the scope of protection of the claims.

The above-mentioned are merely preferred embodiments of the present disclosure and not used to limit the present disclosure. For one skilled in the art, various modifications and changes could be made to the present disclosure. Any modifications, equivalent substitutions, improvements and so on, made within the spirit and principle of the present disclosure, should be covered within the scope of protection of the present disclosure.

What is claimed is:

1. An in-game team-forming method, providing a graphical user interface of a game by a terminal device, and providing a team-forming control on the graphical user interface, comprising steps of:
determining, in response to a touch operation on the team-forming control, a target object according to the touch operation;
determining a target team-forming mode corresponding to the target object based on a mapping relationship between the object and a team-forming mode, wherein the target team-forming mode at least comprises a team-forming task; and
triggering, according to the target team-forming mode, a team-forming instruction corresponding to the target team-forming mode.

2. The in-game team-forming method according to claim 1, wherein a first touch point of the touch operation is located on the team-forming control, and a second touch point of the touch operation is located on the target object.

3. The in-game team-forming method according to claim 2, wherein the touch operation is a dragging operation, and the step of determining a target object according to the touch operation comprises:
determining an object located at an end point position of the dragging operation as the target object.

4. The in-game team-forming method according to claim 2, wherein the touch operation is a dragging operation, and the step of determining a target object according to the touch operation comprises:
making the team-forming control move to an end point position of the dragging operation based on a dragging track of the dragging operation, in response to the dragging operation on the team-forming control.

5. The in-game team-forming method according to claim 1, wherein the touch operation comprises a first touch operation and a second touch operation, and the step of determining, in response to a touch operation on the team-forming control, a target object according to the touch operation comprises:
determining an object at a target position as the target object in response to the first touch operation on the team-forming control and the second touch operation on the target position.

6. The in-game team-forming method according to any one of claims 1-5, wherein the target object comprises: a control, a scene object, and a character object.

7. The in-game team-forming method according to any one of claims 1-5, wherein the step of triggering, according to the target team-forming mode, a team-forming instruction corresponding to the target team-forming mode comprises:
displaying a team-forming confirmation sub-interface on the graphical user interface, wherein the team-forming confirmation sub-interface at least comprises: the target team-forming mode; and
triggering the team-forming instruction corresponding to the target team-forming mode in response to a confirmation operation on the team-forming confirmation sub-interface.

8. The in-game team-forming method according to claim 7, wherein the team-forming confirmation sub-interface further comprises a team-forming option control, and the method further comprises:
sending preset team-forming information corresponding to the team-forming option control by an instant communication, after establishing a team corresponding to the target team-forming mode, in response to a selection operation on the team-forming option control.

9. The in-game team-forming method according to claim 1, wherein the step of determining a target team-forming mode corresponding to the target object based on a mapping relationship between the object and a team-forming mode comprises:
acquiring a pre-configured mapping relationship data table, wherein the mapping relationship data table reflects a mapping relationship between identification information and a team-forming mode of the object; and
determining the target team-forming mode according to the identification information about the target object, based on the mapping relationship between the identification information and the team-forming mode of the object in the mapping relationship data table.

10. The in-game team-forming method according to claim 9, wherein the identification information comprises: a text identification, and the mapping relationship data table comprises a first mapping relationship; and the step of determining the target team-forming mode according to the identification information about the target object, based on the mapping relationship between the identification information and the team-forming mode of the object in the mapping relationship data table comprises:
acquiring the first mapping relationship, wherein the first mapping relationship is used to indicate a mapping relationship between the text identification and the team-forming mode of the object; and
taking a team-forming mode corresponding to the text identification of the target object as the target team-forming mode, based on the first mapping relationship.

11. The in-game team-forming method according to claim 10, wherein before acquiring the first mapping relationship, the method further comprises:
establishing the first mapping relationship between the text identification and the team-forming mode of the object in response to an association configuration operation.

12. The in-game team-forming method according to claim 9, wherein the identification information comprises: image identification, and the mapping relationship data table comprises a second mapping relationship; and the step of determining the target team-forming mode according to the identification information about the target object, based on the mapping relationship between the identification information and the team-forming mode of the object in the mapping relationship data table comprises:
acquiring the second mapping relationship, wherein the second mapping relationship is used to indicate a mapping relationship between the image identification and the team-forming mode of the object; and
taking a team-forming mode corresponding to the image identification of the target object as the target team-forming mode, based on the second mapping relationship.

13. The in-game team-forming method according to claim 12, wherein before acquiring the second mapping relationship, the method further comprises:
establishing the second mapping relationship between the image identification and the team-forming mode of the object in response to an association configuration operation.

14. An in-game team-forming device, providing a graphical user interface of a game by a terminal device, and providing a team-forming control on the graphical user interface, comprising: a responding module, a determining module, and a triggering module, wherein
the responding module is configured to determine, in response to a touch operation on the team-forming control, a target object according to the touch operation;
the determining module is configured to determine a target team-forming mode corresponding to the target object based on a mapping relationship between the target object and a team-forming mode, wherein the target team-forming mode at least comprises a team-forming task; and
the triggering module is configured to trigger, according to the target team-forming mode, a team-forming instruction corresponding to the target team-forming mode.

15. An computer equipment, comprising: a memory and a processor, wherein the memory stores a computer program executable on the processor, and the steps of the in-game team-forming method according to any one of claims 1 to 13 are implemented when the processor executes the computer program.

16. A computer-readable storage medium, wherein the storage medium stores a computer program, and the steps of the in-game team-forming method according to any one of claims 1 to 13 are implemented when the computer program is executed by a processor.
